(19) United States
(12) Patent Application Publication
(10) Pub. No.: US 2014/0117186 A1
(43) Pub. Date: May 1, 2014

(54) UNIVERSAL CEILING MOUNT CLIP TO SUPPORT MULTIPLE TYPES OF CEILING RAILS

(71) Applicants: Gururaj Govindasamy, San Ramon, CA (US); Luke Roelof Maselkowski, Wantage (GB)

(72) Inventors: Gururaj Govindasamy, San Ramon, CA (US); Luke Roelof Maselkowski, Wantage (GB)

(21) Appl. No.: 13/665,633

(22) Filed: Oct. 31, 2012

(51) Int. Cl. F16M 13/02

(52) U.S. Cl. 248/317

(57) ABSTRACT

According to one embodiment of the disclosure, an apparatus comprises a fastening plate and a rail retention unit. The fastening plate is adapted for attaching a wireless network device thereto in order to suspend the device. The rail retention unit is coupled to the fastening plate. The rail retention unit comprises a plurality of retention areas sized to retain at least three different types of ceiling rails.

### FIELD

Embodiments of the disclosure relate to the field of communications, and in particular, to a fastener that is adapted to attach to multiple types of ceiling rails for securing a wireless network device thereto.

### GENERAL BACKGROUND

Over the last decade or so, for most businesses, it has become a necessity for employees to share data over local area networks. To improve efficiency, enhancements have been added to local area networks such as wireless connectivity. This enhancement provides an important extension by enabling the formation of a wireless local area network (WLAN).

Typically, a WLAN features an Access Point (AP). The AP operates as a relay device to receive data frames and transmit data from these frames over a fixed, wired network. Thus, an AP supports communications with both a wireless network and a wired network.

For most commercial applications, APs are installed by attaching these devices to ceiling rails located above the ceiling tiles. Currently, there are four (4) different types of conventional clips that are used for attaching APs to five (5) different types of ceiling rails. The type of clip used depends on the type of ceiling rail present. Only one conventional clip capable of being attached to two different ceiling rails (e.g., Armstrong® Silhouette XL™ ⅛ & ¼ inch ceiling rails).

The use of multiple types of mounting clips increases productivity costs and inventory costs. More specifically, for current AP installations, productivity costs are less than optimal because installers are required to maintain sufficient numbers of different clips. Hence, since more than one type of ceiling clip may be needed for a WLAN installation, there is a likelihood that, at the installation site, installers may discover that they do not have enough ceiling clips of a particular type or may realize that they do not have the correct ceiling clips at all.

In effort to minimize productivity costs, the installers would need to maintain a large number of different mounting clips, including those clips that are used for attachment to less popular or customized ceiling rails. This increases inventory costs incurred by the device manufacturers and/or installers.

### BRIEF DESCRIPTION OF THE DRAWINGS

The invention may best be understood by referring to the following description and accompanying drawings that are used to illustrate embodiments of the disclosure.

FIG. 1 is an exemplary embodiment of a wireless network including a wireless network device deploying a “universal” ceiling mount clip.

FIG. 2 is an exploded view of a first exemplary embodiment of the ceiling mount clip of FIG. 1.

FIGS. 3A-3B are perspective views of the first exemplary embodiment of the ceiling mount clip of FIG. 2 in a closed state and an opened state.

FIG. 4 is a front side view of the first exemplary embodiment of the ceiling mount clip of FIG. 3A.

FIG. 5 is a top plan view of the ceiling mount clip of FIG. 2 in a closed state.

FIG. 6 is a top plan view of the ceiling mount clip of FIG. 2 in an opened state.

FIG. 7 is a perspective view of a second exemplary embodiment of the ceiling mount clip of FIG. 1 in a closed state.

FIG. 8 is a front side view of the second exemplary embodiment of the ceiling mount clip of FIG. 7.

FIGS. 9A-9B are perspective and cross-sectional views of the ceiling mount clip of FIG. 3A attached to a first type of ceiling rail.

FIGS. 10A-10B are perspective and cross-sectional views of the ceiling mount clip of FIG. 3A attached to a second type of ceiling rail.

FIGS. 11A-11B are perspective and cross-sectional views of the ceiling mount clip of FIG. 3A attached to a third type of ceiling rail.

FIGS. 12A-12B are perspective and cross-sectional views of the ceiling mount clip of FIG. 3A attached to a fourth type of ceiling rail.

FIGS. 13A-13B are perspective and cross-sectional views of the ceiling mount clip of FIG. 3A attached to a fifth type of ceiling rail.

FIGS. 14A and 14B are top plan views of the installation of the bottom surface of the fastening plate of the first embodiment of the ceiling mount clip to a wireless network device.

FIG. 15 is a front view of a third exemplary embodiment of the ceiling mount clip of FIG. 1 in a closed state.

FIG. 16 is an exemplary flowchart illustrating connectivity of the ceiling mount clip to a ceiling rail.

### DETAILED DESCRIPTION

Embodiments of the disclosure relate to a fastener that is adapted to coupling to at least three different types of ceiling rails. This fastener, hereafter referred to as a “ceiling mount clip,” comprises a first attachment member that is configured to attach to a ceiling rail and a second attachment member that is configured to attach to a wireless network device. As a result, the wireless network device may be suspended from the ceiling rail.

Herein, the ceiling mount clip comprises a retention unit coupled to a fastening plate. More specifically, according to one embodiment of the disclosure, the retention unit comprises with a first retaining unit affixed to the fastening plate and a second retaining unit that is slidably inserted into and removed a space between a bottom portion of the first retaining unit and a top portion of the fastening plate.

As described below, each retaining unit includes a base and a profile unit. A “profile unit” comprises a substantially vertical frame member having two or more protrusions extending from the frame member. The combination of both profile units form specific retention areas sized to receive flanges associated with each of the different ceiling rails. The fastening plate is adapted for coupling with the wireless network device so that the wireless network device is secured to the particular ceiling rail.

Herein, certain terminology is used to describe features of the disclosure. For example, the term “wireless network device” generally represents electronics that support the receipt and/or transmission of wireless communications including, but not limited or restricted to an Access Point (AP); a base station; a data transfer device (e.g., switch, router, bridge, brouter, etc.); a television; a set-top box; a video gaming console; a television peripheral such as Apple® TV; a communication management device; or the like.

An “interconnect” is generally defined as a communication pathway established over an information-carrying medium. This information-carrying medium may be a physical medium (e.g., electrical wire, optical fiber, cable, bus traces, etc.), a wireless medium (e.g., air in combination with wireless signaling technology) or a combination thereof. The data transferred over the interconnect may be in accordance with a variety of communication protocols including, but not limited or restricted to Ethernet, Token Ring, Asynchronous Transfer Mode (ATM), or the like.

Lastly, the terms “or” and “and/or” as used herein are to be interpreted as inclusive or meaning any one or any combination. Therefore, “X, Y or Z” or “X, Y and/or Z” mean “any of the following: X; Y; Z; X and Y; X and Z; Y and Z; X, Y and Z.” An exception to this definition will occur only when a combination of elements, functions, steps or acts are in some way inherently mutually exclusive.

Certain details are set forth below in order to provide a thorough understanding of various embodiments of the disclosure, albeit the invention may be practiced through many embodiments other that those illustrated. Well-known logic and operations are not set forth in detail in order to avoid unnecessarily obscuring this description.

I. Wireless Network Device with “Universal” Ceiling Mount Clip

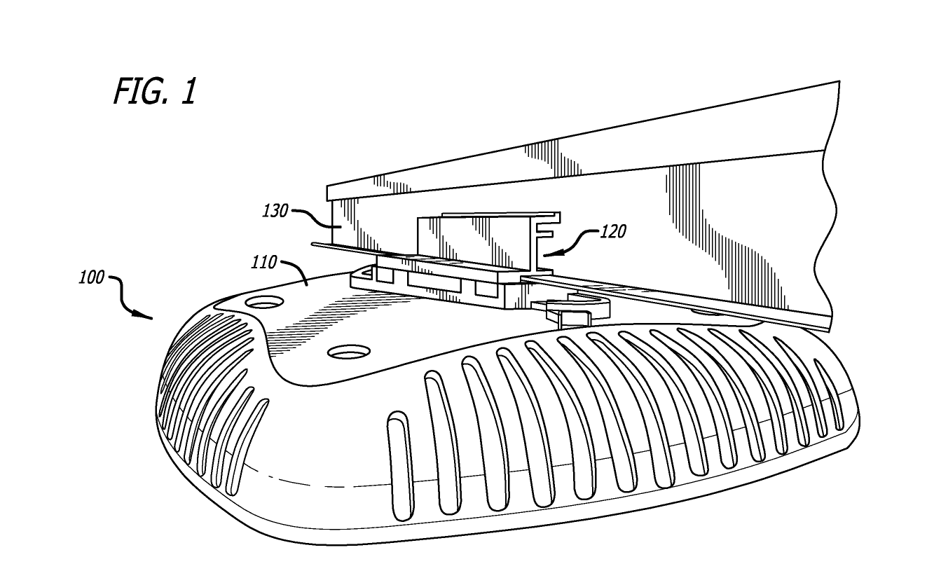

Referring to FIG. 1, an exemplary embodiment of a wireless network device 100 is shown. In accordance with one embodiment of the disclosure, wireless network device 100 is configured to communicate with other devices supporting wireless connectivity. These other devices may include, but are not limited or restricted to a computer, cellular telephone with WiFi™ connectivity, tablet, personal digital assistant “PDA”, net book, or any other device into which wireless communications terminate.

Herein, as part of a wireless local area network (WLAN), wireless network device 100 comprises wireless interface (not shown), such as one or more radios, antenna(s) or the like, that supports wireless communications and/or a wired interface over which data is routed over a wired interconnect. Wireless network device 100 further comprises a cover 110 made of an inflexible material (e.g. hardened plastic, metal, etc.) that features one or more recesses and/or bosses for alignment with corresponding bosses and/or recesses on a bottom surface of a ceiling mount clip 120.

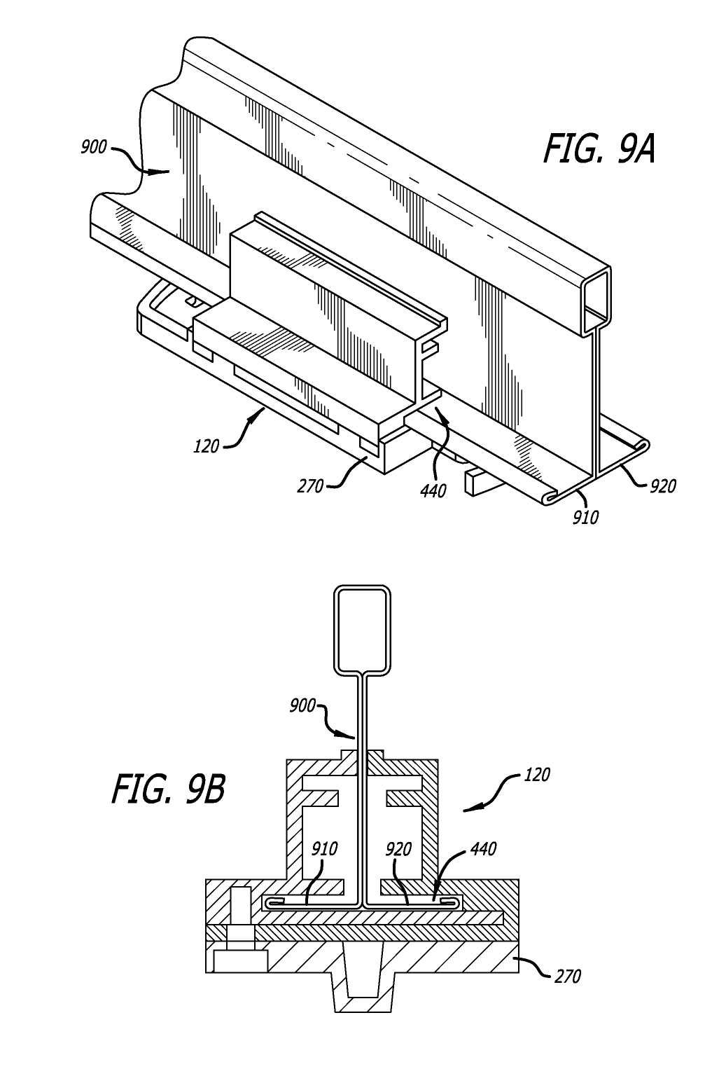

Referring still to FIG. 1, wireless network device 100 is secured to a ceiling rail 130 by ceiling mount clip 120. Herein, ceiling mount clip 120 is configured as a universal fastener for attaching to at least three different types of ceiling rails. For instance, ceiling mount clip 120 may be adapted for attachment to three or more of the following ceiling rails (or ceiling rails of similar construction) as shown in FIGS. 9A-13A: (1) a flat 9/16″ ( 9/16 inch) ceiling rail; (2) a flat 15/16″ ceiling rail; (3) an Interlude XL™ ceiling rail; (4) a ⅛″ ceiling rail; and (5) a ¼″ ceiling rail.

### II. “Universal” Ceiling Mount Clip

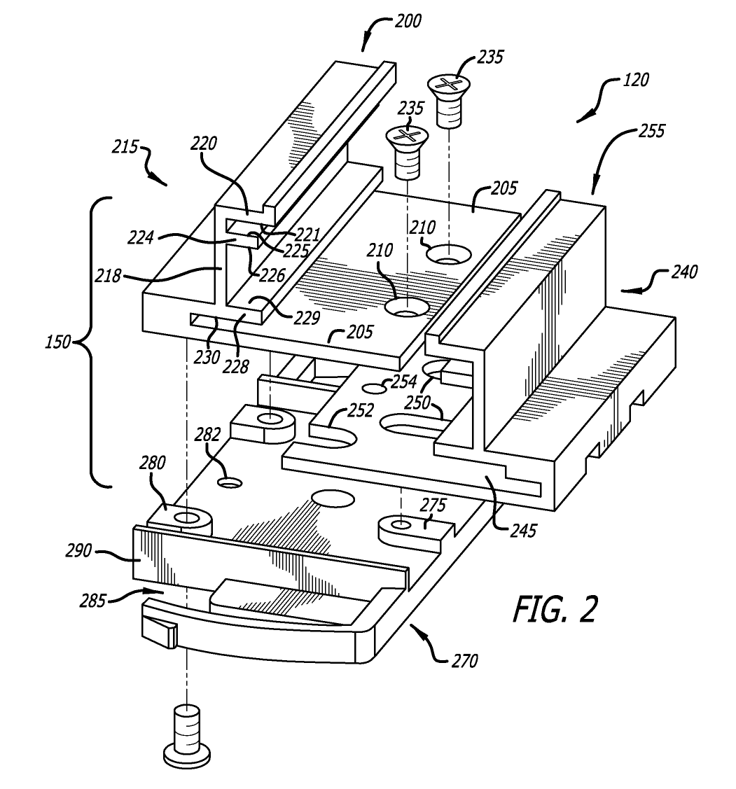

Referring now to FIG. 2, an exploded view of a first exemplary embodiment of ceiling mount clip 120 of FIG. 1 is shown. Ceiling mounting clip 120 comprises a retention unit 150, which includes a first retaining unit 200 and a second retaining unit 240, and a fastening plate 270. According to this embodiment of the disclosure, first retaining unit 200 and second retaining unit 240 are made of a durable, rigid material (e.g., a metal such as aluminum, stainless steel, a hardened plastic, etc.). Fastening plate 270 may be made of the same material, but according to this embodiment, fastening plate 270 is made of a material that is different from the material for retaining units 200 and 240. For instance, fastening plate 270 may be made of a hardened plastic similar in composition to that of cover 110 of wireless network device 100 while retaining units 200 and 240 are made of a chosen metal type.

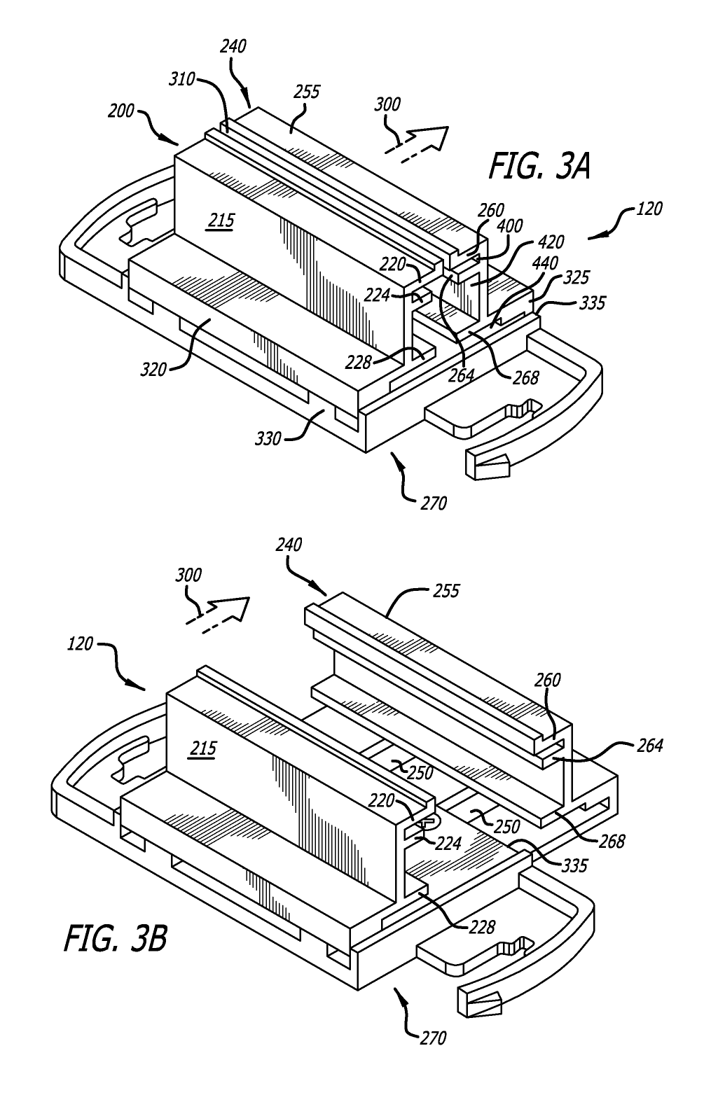

As shown, second retaining unit 240 is interposed between first retaining unit 200 and fastening plate 270. Sufficient spacing is provided between first retaining unit 200 and fastening plate 270 to allow for lateral movement of second retaining unit 240 as described in FIGS. 3A and 3B.

First retaining unit 200 comprises a base 205 and a profile unit 215 extending vertically from base 205. Base 205 comprises a plurality of apertures 210 that are positioned to be aligned corresponding apertures 250 within a base 245 of second retaining unit 240. This alignment allows one or more fastening members 235 (e.g., screw(s), bolt(s), etc.) to be inserted through apertures 210 and 250 and coupled to bosses 275 of fastening plate 270. Hence, first retaining unit 210 and second retaining unit 240 are interlocked to operate in a collective manner.

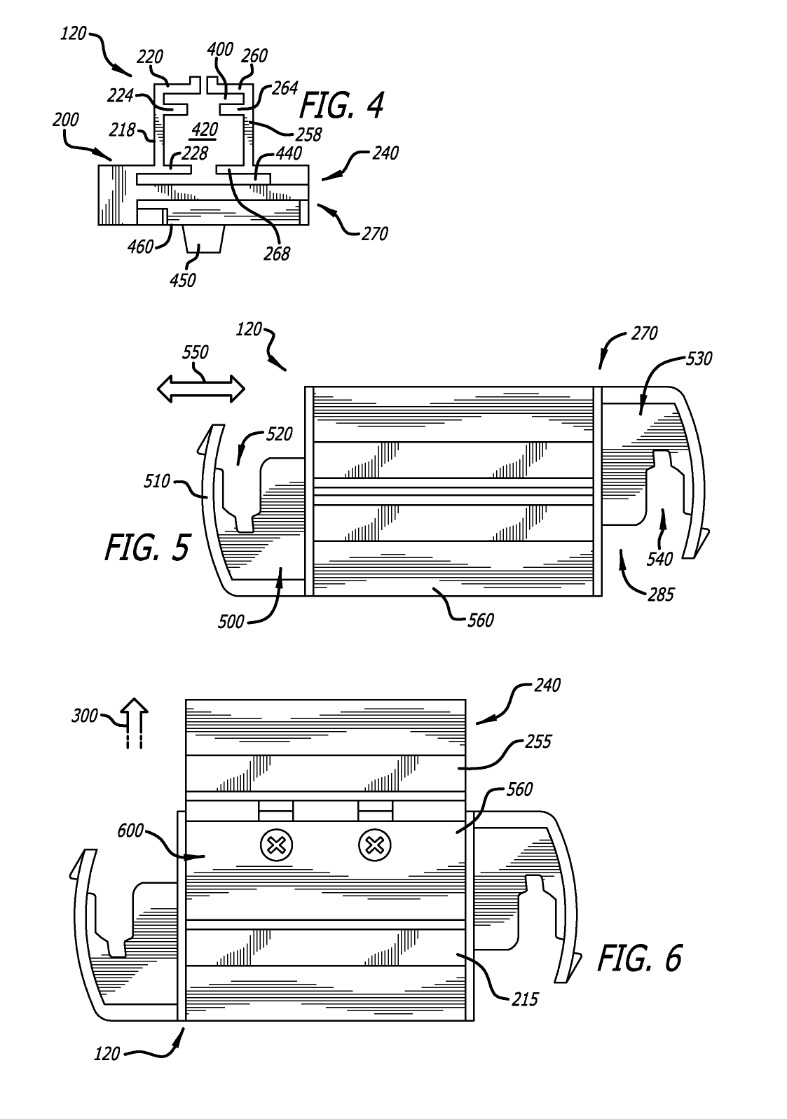

As further shown in FIGS. 2 and 4, profile unit 215 comprises a frame member 218 from which a plurality of protrusions 220, 224 and 228 extend. An inner wall of frame member 218 along with a bottom surface 221 of a first protrusion 220 and a top surface 225 of a second protrusion 224 partially form a first area 400 (FIG. 4) for receiving a flange associated with one type of ceiling rail (e.g., Interlude XL™). Similarly, the inner wall of frame member 218, a bottom surface 226 of second protrusion 224 and a top surface 229 of a third protrusion 228 partially form a second area 420 (FIG. 4) for receiving a flange associated with other types of ceiling rails (e.g., ⅛″ & ¼″ ceiling rails). Lastly, the inner wall of frame member 218 along with a bottom surface 230 of a third protrusion 228 and a top surface 206 of base 205 partially form a third area 440 (FIG. 4) for receiving a flange associated with other types of ceiling rail (e.g., flat 9/16″ & 15/16″ ceiling rails) as further illustrated in FIGS. 4 and 9A-9E.

Having a similar construction as first retaining unit 200, second retaining unit 240 comprises base 245 and second profile unit 255 affixed to base 245. However, one notable difference is that apertures 250 are elongated and sized with a width larger than the diameters of fastening members 235. Provided that second retaining unit 240 is not secured to first retaining unit 200, second retaining unit 240 may be laterally adjusted in a first lateral direction away from first retaining unit 200. This lateral movement of second retaining unit 240 places ceiling mount clip 120 into an opened state to allow a portion of the ceiling rail to be placed in areas 400, 420 or 440.

It is contemplated that second retaining unit 240 may be secured to first retaining unit 200 if second retaining unit 240 is moved laterally in a second lateral direction toward first retaining unit 200 until a cut-out 252 in base 245 of second retaining unit comes into contact with boss 280 of fastening plate 270. At this time, aperture 254 of base 245 and aperture 282 of fastening plate 270 are aligned to receive a fastening member (not shown) that is secured by a portion of first retaining unit 200. This prevents lateral movement of second retaining unit 240 and places ceiling mount clip 120 in a closed state.

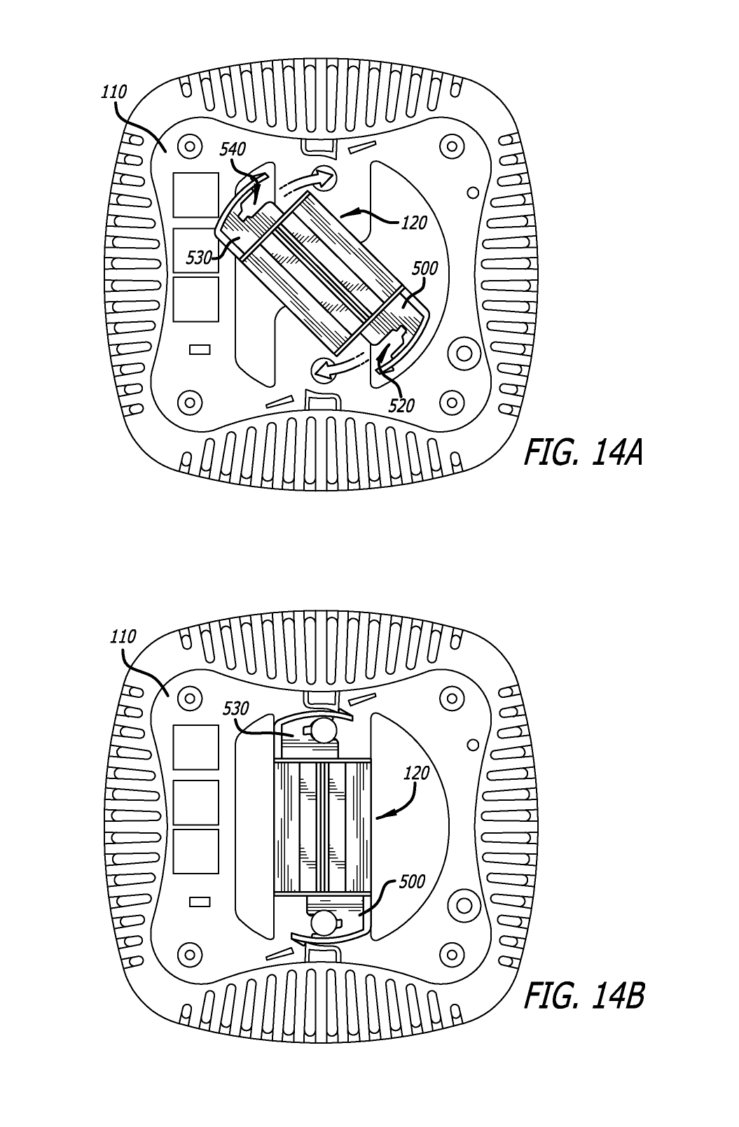

Fastening plate 270 comprises a plurality of bosses (e.g., boss 275, boss 280, etc.). Fastening plate 270 further comprises one or more latch members 285 which, as shown, are spaced apart from a raised wall 290 that may operate as a guide for retaining units 200 and 240. Latch members 285 enable fastening plate 270 to become affixed to bosses extending from cover 110 of wireless network device 100 as illustrated in FIGS. 14A and 14B.

Referring to FIG. 3A, a perspective view of the first exemplary embodiment of ceiling mount clip 120 of FIG. 2 in a closed state is shown. Herein, first and second retaining units 200 and 240 are secured together, where second retaining unit 240 is unable to move laterally in the first lateral direction 300 away from second retaining unit 200 and first profile unit 215 and second profile unit 255 are in close proximity to each other. This creates suitable sized areas 400, 420 and 440 for supporting at least five different ceiling rail types.

In the closed state, ceiling mount clip 120 comprises a channel 310 that is formed between the protrusions 220, 224 and/or 228 of first profile unit 215 and protrusions 260, 264 and/or 268 of second profile unit 255. Channel 310 is sized to accommodate for the thickness of various ceiling rails when ceiling mount clip 120 is secured to that ceiling rail. Furthermore, a side edge 320 of first retaining unit 200 and a side edge 325 of second retaining unit 240 are generally coplanar with side edges 330 and 335 of fastening plate 270.

Referring now to FIG. 3B, a prospective view of the first exemplary embodiment of the ceiling mounting clip 120 of FIG. 2 in an opened state is shown. Herein, second retaining unit 240 is laterally adjusted in the first lateral direction 300 so as to create a larger spacing between the first protrusions 220 and 260, second protrusions 224 and 264, and third protrusions 228 and 268 of profile units 215 and 255, respectively. This is accomplished by disengaging any securing mechanism between first profile unit 215 and second profile unit 255 (e.g., removal of fastening member from apertures 254 and 282) and then sliding second retaining unit 240 in the first lateral direction 300.

The sliding distance is controlled by the length of elongated aperture 250. In other words, when placing ceiling mount clip 120 into an opened state, the location of fastening member 235 within elongated aperture(s) 250 generally moves from one end to the other. In the opened state, second retaining unit 240 is moved laterally so that a substantial portion of second retaining unit 240 extends beyond edge 335 of fastening plate 270.

Referring now to FIG. 4, a front side view of the first exemplary embodiment of ceiling mount clip 120 of FIG. 3A is shown. Herein, first retaining unit 200 comprises frame member 218, first protrusion 220, second protrusion 224, and third protrusion 228. Likewise, second retaining unit 240 comprises first protrusion 260, second protrusion 264 and third protrusion 268 extending from frame member 258. As shown, protrusions 260, 264 and 268 of second retaining unit 240 mirror protrusions 220, 224 and 228. This arrangement creates spacing including first area 400, second area 420 and third area 440.

According to this embodiment of the disclosure, as shown, first area 400 features a height of approximately 1.8 mm (millimeters) which is substantially similar to the height of third area 440. Second area 420 has a height of approximately 9 mm with a width of approximately 14.6 mm. The width of first area 400 is approximately 14.6 mm while the width of third area 440 is approximately 24.4 mm. Hence, first and third areas 400 and 440 are configured with the same approximate height and the first and second areas 400 and 420 are configured with the same approximate width. Second area 420 has the largest height while third area 440 has the largest width.

A boss 450 is positioned on a bottom surface 460 of fastening plate 270 to insertion into a corresponding recess within a top surface of cover 110 of wireless network device 100 as shown in FIG. 1.

Referring now to FIG. 5, a top plan view of ceiling mount clip 120 in a closed state is shown. Herein, fastening plate 270 of ceiling mount clip 120 comprises latch members 285, in particular a first latch member 500 and a second latch member 530. Latch members 500 and 530 are oriented on opposite sides of a base member 560 so that, when fastening plate 270 is rotated in a clockwise direction, latch members 500 and 530 will attach to bosses in cover 110 of wireless network device 100 as shown in FIGS. 14A and 14B.

More specifically, as shown in FIGS. 5, 14A and 14B, positioned on the outer portion of fastening plate 270, first latch member 500 comprises a convex member 510 that is flexible in a longitudinal direction 550 so that a boss protruding from the top surface of cover 110 is secured within fastening area 520. The same architecture is applicable to the second latch member 530 so that a corresponding boss on cover 110 is secured within fastening area 540.

Referring now to FIG. 6, a top plan view of ceiling mount clip 120 when placed in an opened state is shown. Herein, second retaining unit 240 extends in lateral direction 300 so that an opening 600 created between first profile unit 215 and second profile unit 255 is enlarged in size to receive flanges associated with the particular ceiling rail as illustrated in FIGS. 9A-9E.

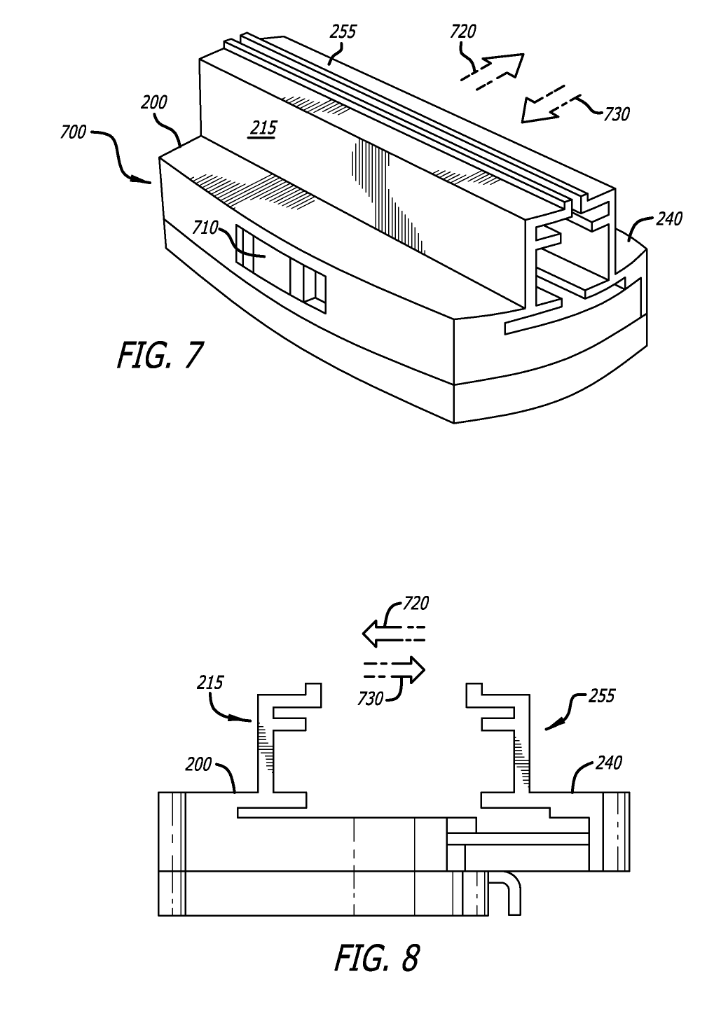

Referring now to FIG. 7, a second exemplary embodiment of ceiling mount clip of FIG. 1 in a closed state is shown. Herein, ceiling mount clip 700 comprises the same structure for first retaining unit 200 and second retaining unit 240. However, in lieu of using a fastening member (e.g., screw and boss mechanism as set forth in the first exemplary embodiment), first profile unit 215 and second profile unit 255 are secured into an interlocking position by a spring mechanism.

As shown in FIGS. 7 and 8, upon activation of a latch button 710, the spring mechanism is released so that second profile unit 255 can be adjusted in a first lateral direction 720 for placing ceiling mount clip 120 into an opened state. Upon applying a force in a second lateral direction 730, being opposite to first lateral direction 720, the spring mechanism is reset so that, at a certain point, ceiling mount clip 120 is placed into a closed (and secured) state, preventing substantial lateral movement by second profile unit 255.

Referring to FIGS. 9A-9B, perspective and cross-sectional views of ceiling mount clip 120 of FIG. 3A attached to a first type of ceiling rail is shown. A ceiling rail 900 is provided with a first rail type such as a flat 9/16″ ceiling rail (e.g., Armstrong® Suprafine™ 9/16). Ceiling rail 900 comprises a pair of flanges 910 and 920 that that are positioned toward an edge 930 of rail 900 and extend in opposite directions. When ceiling mount clip 120 is placed in an opened state, these flanges 910 and 920 are positioned within third area 440 of ceiling mount clip 120. Thereafter, ceiling mount clip 120 is returned back to a closed state with flanges 910 and 920 fully residing within third area 440. This allows a wireless network device to be coupled to fastening plate 270 of ceiling mount clip 120 thereby suspending the wireless network device from ceiling rail 900.

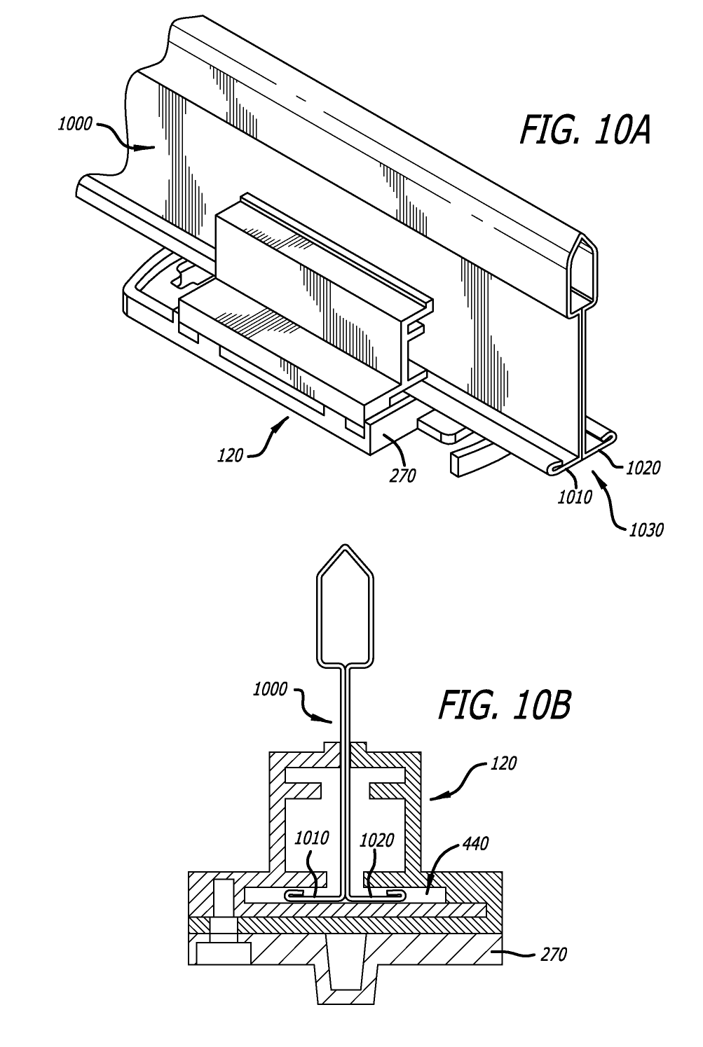

Referring now to FIGS. 10A-10B, perspective and cross-sectional views of ceiling mount clip 120 of FIG. 3A attached to a second type of ceiling rail is shown. A ceiling rail 1000 is provided with a second rail type such as a flat 15/16″ ceiling rail (e.g., Armstrong® Prelude™ 15/16). Ceiling rail 1000 comprises a pair of flanges 1010 and 1120 that are positioned toward an edge 1030 of rail 1000 and extend in opposite directions. When ceiling mount clip 120 is placed in an opened state, these flanges 1010 and 1020 are positioned within third area 440 of ceiling mount clip 120. Thereafter, ceiling mount clip 120 is returned back to a closed state with flanges 1010 and 1020 fully residing within third area 440. This allows a wireless network device to be coupled to fastening plate 270 of ceiling mount clip 120 thereby suspending the wireless network device from ceiling rail 1000.

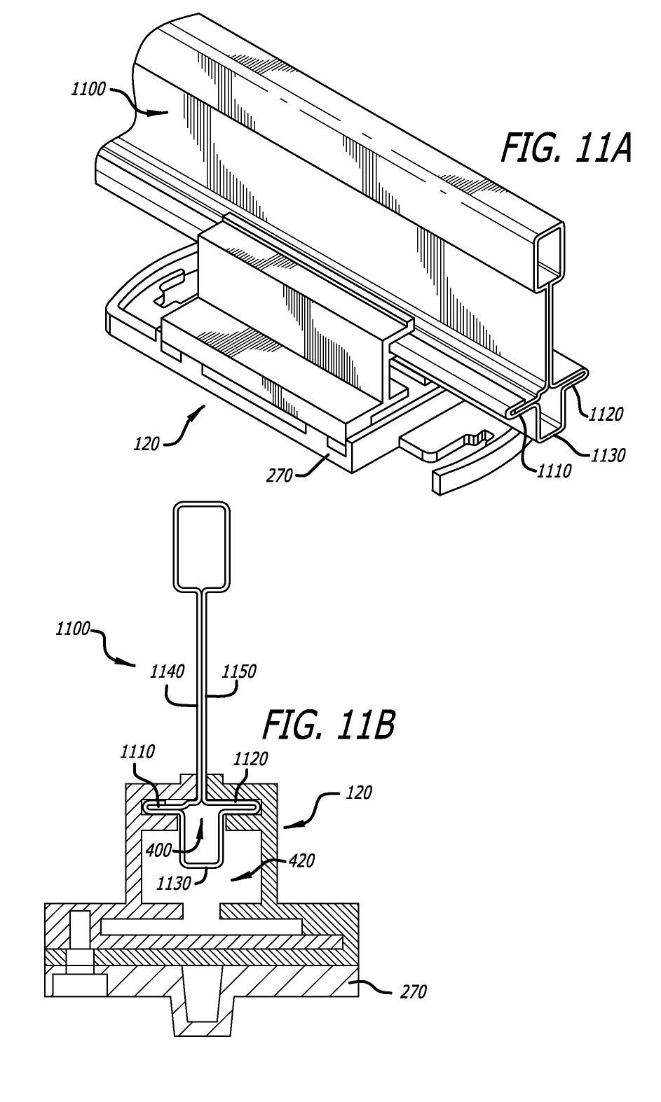

Referring now to FIGS. 11A-11B, perspective and cross-sectional views of ceiling mount clip 120 of FIG. 3A attached to a third type of ceiling rail is shown. A ceiling rail 1100 is provided with a third rail type such as an Armstrong® Interlude™ XL ceiling rail. As illustrated by the cross sectional view of ceiling rail 1100 in FIG. 11B, rail 1100 comprises a pair of flanges 1110 and 1120 that extend in opposite directions from rail 1100 with an edge 1130 of rail 1100 having a width larger than the pair of rail portions 1140 and 1150 collectively forming ceiling rail 1100. When ceiling mount clip 120 is placed in an opened state, these flanges 1110 and 1120 are positioned within first area 400 of ceiling mount clip 120 with edge 1130 residing within second area 420. Thereafter, ceiling mount clip 120 is returned back to a closed state with flanges 1110 and 1120 fully residing within first area 400. This allows a wireless network device to be coupled to fastening plate 270 of ceiling mount clip 120 thereby suspending the wireless network device from ceiling rail 1100.

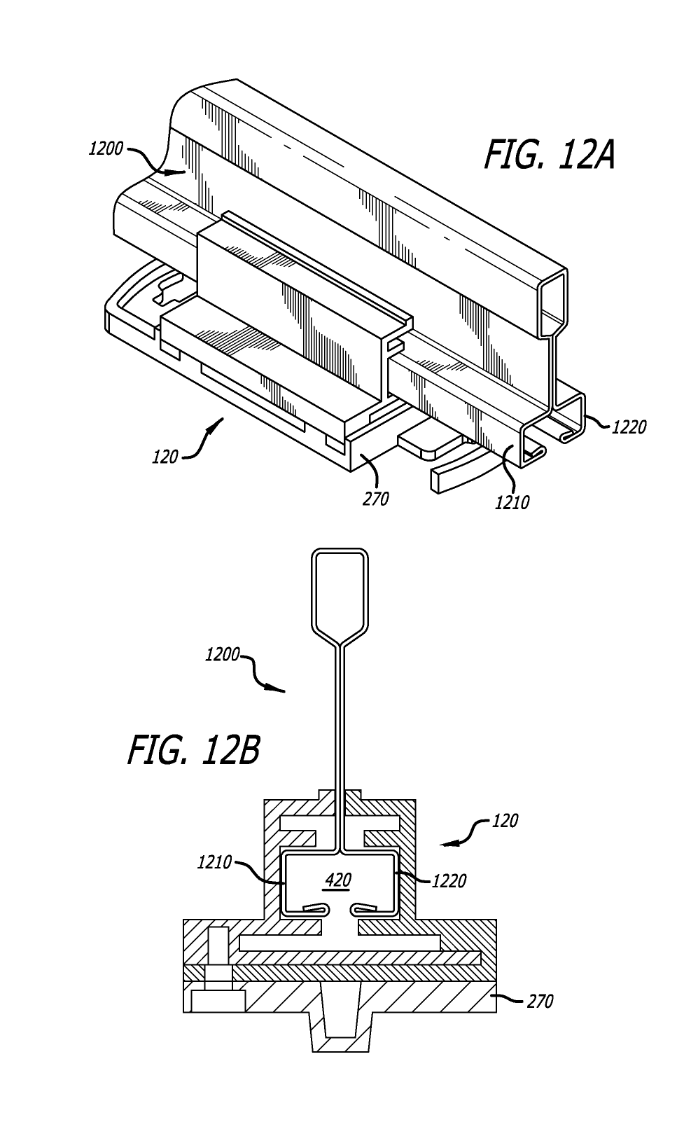

Referring now to FIGS. 12A-12B, perspective and cross-sectional views of ceiling mount clip 120 of FIG. 3A attached to a fourth type of ceiling rail is shown. A ceiling rail 1200 is provided with a fourth rail type such as an ⅛″ ceiling rail (e.g., Armstrong® Silhouette™ XL). Ceiling rail 1200 comprises a pair of flanges 1210 and 1220 that extend in opposite directions from rail 1200. When ceiling mount clip 120 is placed in an opened state, these flanges 1210 and 1220 are positioned within second area 420 of ceiling mount clip 120. Thereafter, ceiling mount clip 120 is returned back to a closed state with flanges 1210 and 1220 fully residing within second area 420. This allows a wireless network device to be coupled to fastening plate 270 of ceiling mount clip 120 thereby suspending the wireless network device from ceiling rail 1200.

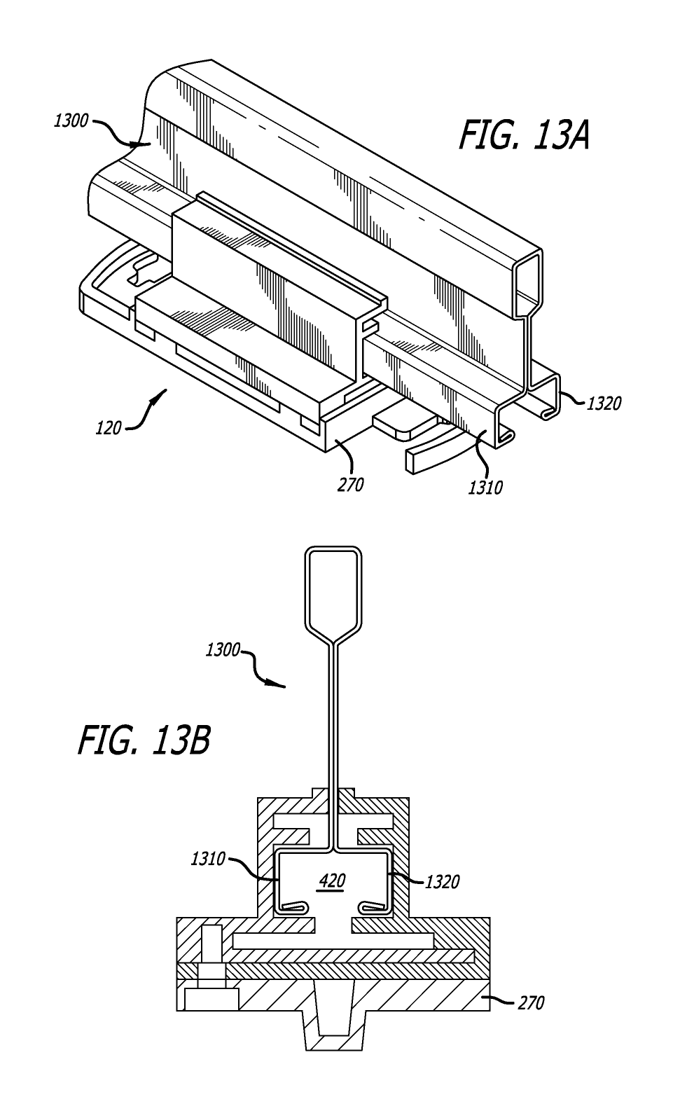

Referring to FIGS. 13A-13B, perspective and cross-sectional views of ceiling mount clip 120 of FIG. 3A attached to a fifth type of ceiling rail is shown. A ceiling rail 1300 is provided with a fifth rail type such as a ¼″ ceiling rail (e.g., Armstrong® Silhouette™ XL). Ceiling rail 1300 comprises a pair of flanges 1310 and 1320 that extend in opposite directions from rail 1300. When ceiling mount clip 120 is placed in an opened state, these flanges 1310 and 1320 are positioned within second area 420 of ceiling mount clip 120. Thereafter, ceiling mount clip 120 is returned back to a closed state with flanges 1310 and 1320 fully residing within second area 420. This allows a wireless network device to be coupled to fastening plate 270 of ceiling mount clip 130 thereby suspending the wireless network device from ceiling rail 1300.

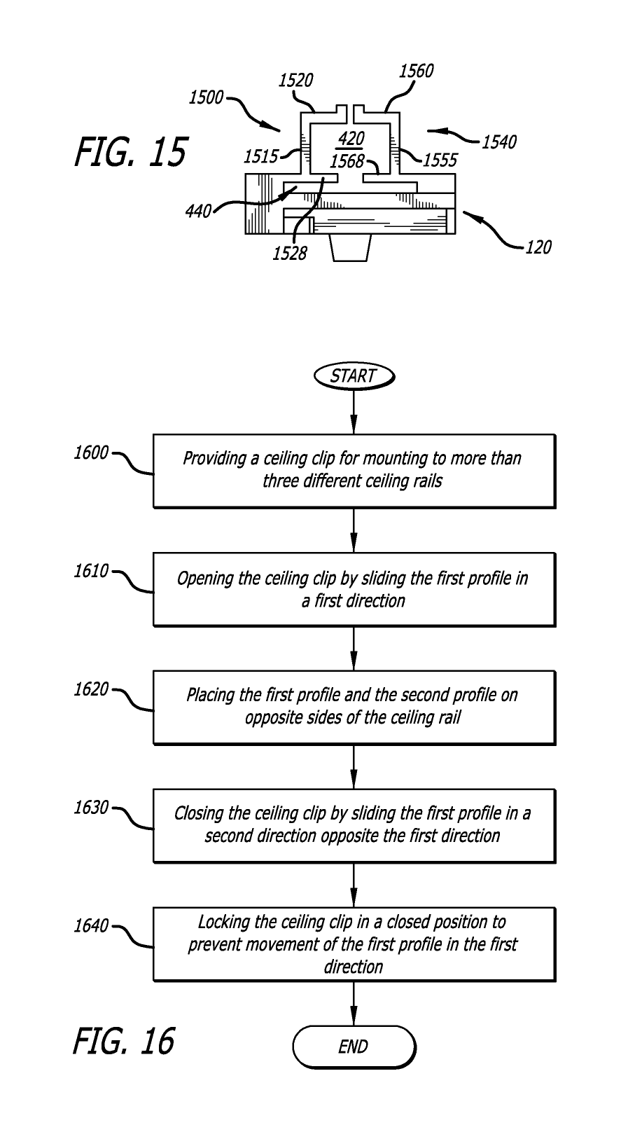

Referring now to FIG. 15, a front view of a third exemplary embodiment of ceiling mount clip 120 of FIG. 1 in a closed state is shown. Herein, ceiling mount clip 120 comprises a fastening plate 1570 identical to fastening plate 270 of FIG. 2. Further, first retaining unit 1500 and a second retaining unit 1540 is substantially similar to first retaining unit 200 and second retaining unit 240 of FIG. 2. The difference between the first and third exemplary embodiments of ceiling mount clip 120 is directed to the architecture of a first profile unit 1515 and a second profile unit 1555. Herein, both first and second profile units 1515 and 1555 comprise only two protrusions, namely protrusions 1520 and 1528 for first profile unit 1515 and protrusions 1560 and 1568 for second profile unit 1555. As a result, only areas 420 and 440 are provided so that ceiling mount clip 120 may be coupled to four ceiling rail types described above, excluding a ceiling rail having a construction similar to the Armstrong® Interlude™ XL ceiling rail.

### III. Connectivity of “Universal” Ceiling Mount Clip

Referring to FIG. 16, an exemplary flowchart illustrating connectivity of a ceiling mount clip to a ceiling rail is shown. Herein, the “universal” ceiling mount clip for mounting to more than three different ceiling rails is provided (block 1600). Thereafter, an opening (channel) for the ceiling mount clip is enlarged by sliding the second retaining unit in a first lateral direction for placement of the clip into an opened state (block 1610). The first profile unit and the second profile unit of the ceiling mount clip are placed on opposite sides of the ceiling rail so that a first flange of the ceiling rail may be placed in one portion of a chosen retention area while a second flange of the ceiling rail is placed in another portion of the retention area (block 1620).

Next, the ceiling mount clip is placed into a closed state by sliding the second retaining unit in a second lateral direction opposite the first lateral direction (block 1630). Hence, the chosen retention area, formed by members of the first and second profile units, retains the flange. The ceiling mount clip is locked to prevent lateral movement of the second retaining unit and ensure that the flanges are securely maintained within the chosen retention area (block 1640).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as determined by the appended claims and their equivalents. The description is thus to be regarded as illustrative instead of limiting.

What is claimed is:

1. An apparatus comprising:
a fastening plate adapted for attachment to a wireless network device; and
a rail retention unit coupled to the fastening plate, the rail retention unit comprises at least one retaining unit that is laterally adjustable when the apparatus is placed in a particular state to accommodate two or more different types of ceiling rails.

2. The apparatus of claim 1, wherein the rail retention unit comprises a plurality of retention areas sized to retain at least three different types of ceiling rails.

3. The apparatus of claim 2, wherein the rail retention unit comprises a first retaining unit affixed to the fastening plate and a second retaining unit that is affixed to the fastening plate when the apparatus is placed in a first state and is laterally adjustable when the apparatus is placed in a second state.

4. The apparatus of claim 3, wherein the first retaining unit includes a first base, a first frame member extending vertically from the first base, and a plurality of protrusions extending longitudinally from the first frame member.

5. The apparatus of claim 4, wherein the second retaining unit includes a second base, a second frame member extending vertically from the second base, and a plurality of protrusions extending longitudinally from the second frame member.

6. The apparatus of claim 5, wherein the plurality of protrusions of the first retaining unit extend in a first direction and the plurality of protrusions of the second retaining unit extend in a second direction, wherein the second direction is in a direction opposite from the first direction from a direction.

7. The apparatus of claim 6, wherein the plurality of retention areas comprises a first retention area being an area formed by (i) a first protrusion and a second protrusion of the plurality of protrusions of the first retaining unit and (ii) a first protrusion and a second protrusion of the plurality of protrusions of the second retaining unit.

8. The apparatus of claim 7, wherein the plurality of retention areas further comprise a second retention area being an area formed by (i) the second protrusion and a top surface of the base of the first retaining unit and (ii) the second protrusion and a top surface of the base of the second retaining unit.

9. The apparatus of claim 8, wherein the plurality of retention areas further comprise a third retention area being an area formed by (i) a third protrusion and the first protrusion of the first retaining unit and (ii) a third protrusion and the first protrusion of the second retaining unit.

10. The apparatus of claim 8, wherein the first retention area being sized for retaining flanges associated with a first type of ceiling rail and a second type of ceiling rail and the second retention area being sized for retaining flanges associated with a third type of ceiling rail and a fourth type of ceiling rail, wherein the first, second, third and fourth types of ceiling rails being different from each other.

11. An apparatus comprising:
a fastening plate adapted for attachment to a wireless network device; and
a rail retention unit coupled to the fastening plate, the rail retention unit comprises
a first retaining unit comprises a first base that is coupled to the fastening plate and a first profile unit vertically extending from the first base, the first profile unit including a first member extending from the base and a plurality of protrusions extending longitudinally from the first member, and
a second retaining unit laterally adjustable from the first retaining unit and the fastening plate, the second retaining unit comprises a second base and a second profile unit, the second profile unit including a second member vertically extending from the second base and a plurality of protrusions extending longitudinally from the second member in a direction opposite to a direction of the plurality of protrusions of the first profile unit.

12. The apparatus of claim 11, wherein the second retaining unit is affixed to the fastening plate when the apparatus is placed in a first state and is laterally adjustable when the apparatus is placed in a second state.

13. The apparatus of claim 12, wherein the plurality of protrusions of the first profile unit and the plurality of protrusions of the second profile unit collectively forming a plurality of retention areas sized for coupling to at least three different types of ceiling rails.

14. The apparatus of claim 13, wherein the plurality of retention areas comprises a first retention area being an area formed by (i) a first protrusion and a second protrusion of the plurality of protrusions of the first profile unit and (ii) a first protrusion and a second protrusion of the plurality of protrusions of the second profile unit.

15. The apparatus of claim 14, wherein the plurality of retention areas further comprise a second retention area being an area formed by (i) the second protrusion and a top surface of the first base of the first retaining unit and (ii) the second protrusion and a top surface of the second base of the second retaining unit.

16. The apparatus of claim 15, wherein the plurality of retention areas further comprise a third retention area being an area formed by (i) a third protrusion and the first protrusion of the first profile unit and (ii) a third protrusion and the first protrusion of the second profile unit.

17. The apparatus of claim 15, wherein the first retention area being sized for retaining flanges associated with a first type of ceiling rail and a second type of ceiling rail and the second retention area being sized for retaining flanges associated with a third type of ceiling rail and a fourth type of ceiling rail, wherein the first, second, third and fourth types of ceiling rails being different from each other.

18. An apparatus comprising:
a fastening plate that is adapted for coupling to a cover of a wireless network device; and
a rail retention unit coupled to the fastening plate, the rail retention unit comprises a plurality of retention areas sized to retain flanges for at least three different types of ceiling rails to suspend the wireless network device in an elevated state.

19. The apparatus of claim 18, wherein the rail retention unit comprises a first retaining unit affixed to the fastening plate and a second retaining unit that is affixed to the fastening plate when the apparatus is placed in a first state and is laterally adjustable when the apparatus is placed in a second state.

20. The apparatus of claim 18, wherein a first retaining unit of the plurality of retaining units includes a first base, a first frame member extending vertically from the first base, and a plurality of protrusions extending longitudinally from the first frame member in a first direction, and wherein the second retaining unit of the plurality of retaining units includes a second base, a second frame member extending vertically from the second base, and a plurality of protrusions extending longitudinally from the second frame member in a second direction opposite to the first direction.

21. The apparatus of claim 20, wherein the plurality of retention areas comprises a first retention area being an area formed by (i) a first protrusion and a second protrusion of the plurality of protrusions of the first retaining unit and (ii) a first protrusion and a second protrusion of the plurality of protrusions of the second retaining unit.

22. The apparatus of claim 21, wherein the plurality of retention areas further comprise a second retention area being an area formed by (i) the second protrusion and a top surface of the base of the first retaining unit and (ii) the second protrusion and a top surface of the base of the second retaining unit.

23. The apparatus of claim 22, wherein the plurality of retention areas further comprise a third retention area being an area formed by (i) a third protrusion and the first protrusion of the first retaining unit and (ii) a third protrusion and the first protrusion of the second retaining unit, the third retention area being positioned above the first retention area with the first retention area being positioned above the second retention area.

24. The apparatus of claim 22, wherein the first retention area being sized for retaining flanges associated with a first type of ceiling rail and a second type of ceiling rail and the second retention area being sized for retaining flanges associated with a third type of ceiling rail and a fourth type of ceiling rail, wherein the first, second, third and fourth types of ceiling rails being different from each other.
